(19) United States
(12) Patent Application Publication
(10) Pub. No.: US 2017/0372843 A1
(43) Pub. Date: Dec. 28, 2017

(54) ELECTROLYTIC CAPACITOR AND METHOD FOR MANUFACTURING SAME

(71) Applicant: Panasonic Intellectual Property Management Co., Ltd., Osaka (JP)

(72) Inventor: TAKAYUKI MATSUMOTO, Yamaguchi (JP)

(21) Appl. No.: 15/701,553

(22) Filed: Sep. 12, 2017

Related U.S. Application Data
(63) Continuation of application No. PCT/JP2016/000891, filed on Feb. 19, 2016.

(30) Foreign Application Priority Data
Mar. 31, 2015 (JP) 2015-073223

(51) Int. Cl. H01G 9/028; C25B 1/04

(52) U.S. Cl. CPC H01G 9/028; C25B 1/04; H01M 2300/0082

(57) ABSTRACT

An electrolytic capacitor includes an anode member, a solid electrolyte layer, and a nonaqueous solvent or an electrolyte solution. The anode member includes a dielectric layer. The solid electrolyte layer includes a conductive polymer formed on a surface of the dielectric layer. The nonaqueous solvent or the electrolyte solution includes a first solvent and a second solvent different from the first solvent. The first solvent contains at least one selected from the group consisting of a carbonate ester and a derivative of the carbonate ester.

### RELATED APPLICATIONS

This application is a continuation of the PCT International Application No. PCT/JP2016/000891, filed on Feb. 19, 2016, which claims the benefit of foreign priority of Japanese patent application No. 2015-073223, filed on Mar. 31, 2015, the contents all of which are incorporated herein by reference.

### BACKGROUND

### 1. Technical Field

The present disclosure relates to an electrolytic capacitor having an excellent property in withstand voltage characteristics and reliability, and a method for manufacturing the electrolytic capacitor.

### 2. Description of the Related Art

Along with digitalization of electronic devices, a small-sized capacitor having large capacitance and low equivalent series resistance (ESR) in a high frequency range has been required.

A promising candidate as the small-sized, large capacitance, and low ESR capacitor is an electrolytic capacitor including, as a cathode material, a conductive polymer such as polypyrrole, polythiophene, polyfuran, or polyaniline For example, a solid electrolytic capacitor including a dielectric layer-formed anode foil, and a solid electrolyte layer as a cathode material, is proposed, the solid electrolyte layer being provided on the dielectric layer-formed anode foil.

It has been pointed out that the solid electrolytic capacitor is insufficient in restoration performance of the dielectric layer and is thus low in withstand voltage characteristics. Therefore, a technique that combines the solid electrolyte layer with a solvent or an electrolyte solution excellent in restoration performance of the dielectric layer has been developed. For example, Unexamined Japanese Patent Publication No. 2009-111174 discloses an electrolytic capacitor obtained by impregnating a solid electrolyte layer with a solvent containing, for example, γ-butyrolactone or sulfolane.

### SUMMARY

An electrolytic capacitor according to the present disclosure includes an anode member, a solid electrolyte layer, and a nonaqueous solvent or an electrolyte solution. The anode member includes a dielectric layer. The solid electrolyte layer includes a conductive polymer formed on a surface of the dielectric layer. The nonaqueous solvent or the electrolyte solution includes a first solvent and a second solvent different from the first solvent. The first solvent contains at least one selected from the group consisting of a carbonate ester and a derivative of the carbonate ester.

According to the present disclosure, it is possible to provide an electrolytic capacitor having an excellent property in withstand voltage characteristics and reliability.

### BRIEF DESCRIPTION OF THE DRAWINGS

FIG. 1 is a schematic sectional view illustrating an electrolytic capacitor according to an exemplary embodiment; and

FIG. 2 is a schematic view illustrating a configuration of a capacitor element according to the exemplary embodiment.

### DETAILED DESCRIPTION OF EMBODIMENT

Generally, electrostatic capacity of an electrolytic capacitor changes according to operating temperature. For the electrolytic capacitor, a property of less changing the electrostatic capacity according to operating temperature, which is namely excellent temperature characteristics, and durability (hereinafter, collectively referred to as reliability) has been required because application of electronic devices on which the electrolytic capacitor is mounted is being versatile. However, the withstand voltage characteristics and the reliability greatly depend on a type of a solvent used in the solid electrolytic capacitor.

An electrolytic capacitor of the present disclosure includes an anode member, a solid electrolyte layer, and a nonaqueous solvent or an electrolyte solution. The anode member includes a dielectric layer. The solid electrolyte layer includes a conductive polymer formed on a surface of the dielectric layer. The nonaqueous solvent or the electrolyte solution includes a first solvent and a second solvent different from the first solvent. The first solvent contains at least one selected from the group consisting of a carbonate ester and a derivative of the carbonate ester. This configuration improves the withstand voltage characteristics and the reliability of the electrolytic capacitor.

The carbonate ester is preferably at least one selected from the group consisting of dimethyl carbonate, diethyl carbonate, ethylene carbonate, and propylene carbonate. These carbonate esters further improve the withstand voltage characteristics and the reliability.

The second solvent preferably contains at least one selected from the group consisting of ethylene glycol, γ-butyrolactone, and sulfolane. The second solvent containing such a component improves an impregnation property of the nonaqueous solvent or the electrolyte solution into the solid electrolyte layer to further improve the withstand voltage characteristics.

A mass ratio between the first solvent and the second solvent (first solvent:second solvent) preferably ranges from 3:7 to 5:5. In other words, a mass ratio of the first solvent to the second solvent preferably ranges from 3/7 to 1. Such a ratio decreases variation in characteristics from a low temperature range to a high temperature range to further improve the reliability.

The conductive polymer preferably includes at least one selected from the group consisting of polypyrrole, polythiophene, polyaniline, and derivatives of these compounds. Addition of such a compound enhances a mutual action between the conductive polymer and the solvent (electrolyte solution) containing a carbonate ester and/or a derivative of the carbonate ester to further improve the withstand voltage characteristics.

The solid electrolyte layer is preferably formed by applying a conductive polymer solution or a conductive polymer dispersion liquid to a surface of the dielectric layer and then drying the conductive polymer solution or the conductive polymer dispersion liquid, the conductive polymer solution being obtained by dissolving the conductive polymer in a third solvent and the conductive polymer dispersion liquid containing the third solvent and particles of the conductive polymer. Such formation improves an impregnation property of the nonaqueous solvent or the electrolyte solution into the solid electrolyte layer to further improve the withstand voltage characteristics.

Hereinafter, the present disclosure is more specifically described with reference to an exemplary embodiment. The exemplary embodiment described below, however, is not to limit the present disclosure.

### Electrolytic Capacitor

An electrolytic capacitor according to the present disclosure includes a solid electrolyte layer and a nonaqueous solvent or an electrolyte solution. The nonaqueous solvent or the electrolyte solution includes a first solvent containing at least one selected from the group consisting of a carbonate ester and a derivative of the carbonate ester, and a second solvent different from the first solvent.

Conventionally, an electrolytic capacitor that is obtained by impregnating a solid electrolyte layer with a high boiling point solvent such as ethylene glycol (EG) or sulfolane has been known, from the viewpoint of improving the withstand voltage characteristics. Only utilization of the high boiling point solvent to a capacitor element including the solid electrolyte layer, however, cannot be expected to sufficiently improve the withstand voltage characteristics and the reliability. This is because a type of the solvent (electrolyte solution) with which the capacitor element is impregnated largely affects the withstand voltage characteristics and the reliability in the electrolytic capacitor including the solid electrolyte layer.

For example, use of EG as a solvent sometimes decreases the withstand voltage characteristics or increases the ESR. Use of EG together with a carbonate ester and/or a derivative of the carbonate ester, however, improves the withstand voltage characteristics and suppresses an increase in ESR. Sulfolane is excellent in high temperature characteristics but solidifies at low temperatures, decreasing capacity. Use of sulfolane together with a carbonate ester and/or a derivative of the carbonate ester, however, improves low temperature characteristics.

That is, the electrolytic capacitor according to the present invention includes, as the solvent (electrolyte solution) with which the solid electrolyte layer is impregnated, the first solvent containing at least one selected from the group consisting of a carbonate ester and a derivative of the carbonate ester, and the second solvent different from the first solvent. This configuration improves both the withstand voltage characteristics and the reliability. A reason why this configuration improves both the withstand voltage characteristics and the reliability is not clear, but it is considered that the improvement is brought by a mutual action between the solvent (electrolyte solution) containing a carbonate ester and/or a derivative of the carbonate ester and the conductive polymer included in the solid electrolyte layer.

Specifically, the first solvent is preferably, for example, dimethyl carbonate (DMC), diethyl carbonate (DEC), ethylene carbonate (EC), or propylene carbonate (PC). Alternatively, the first solvent may be derivatives of these carbonate esters, such as a fluorine-containing carbonate ester, namely fluoroethylene carbonate, for example. These carbonate esters and/or derivatives of these carbonate esters may be used alone or in combination of a plurality of carbonate esters and/or derivatives of the carbonate esters. Especially, PC is preferable in terms of the fact that PC has a high boiling point and a low congealing point.

While PC is a high boiling point solvent, use of the electrolytic capacitor including PC as the solvent is conventionally said to decrease the reliability at high temperatures. Use of, as the solvent, a solvent (second solvent) different from PC in addition to PC, however, improves the reliability at high temperatures.

The second solvent may be any solvent as long as the solvent is different from the first solvent, and is not particularly limited. The second solvent is, for example, a high boiling point solvent having a boiling point of 180° C. or more. Examples of the high boiling point solvent include ethylene glycol (EG), γ-butyrolactone (GBL), and sulfolane. These compounds may be used alone or in combination of a plurality of compounds.

A mass ratio between the first solvent and the second solvent (first solvent:second solvent) preferably ranges from 2:8 to 5:5. With the mass ratio in this range, the reliability can be expected to further increase. The mass ratio between the first solvent and the second solvent (first solvent second solvent) more preferably ranges from 3:7 to 5:5.

The conductive polymer included in the solid electrolyte layer is preferably, for example, polypyrrole, polythiophene, or polyaniline. These conductive polymers may be used alone or in combination of two or more conductive polymers, or may be a copolymer of two or more monomers. The solid electrolyte layer including such a conductive polymer can be expected to further improve the withstand voltage characteristics.

In the present specification, polypyrrole, polythiophene, polyaniline, and the like mean polymers having, as a basic skeleton, polypyrrole, polythiophene, polyaniline, and the like, respectively. Therefore, polypyrrole, polythiophene, polyaniline, and the like also include derivatives of polypyrrole, polythiophene, polyaniline, and the like, respectively. For example, polythiophene includes poly(3,4-ethylenedioxythiophene) and the like.

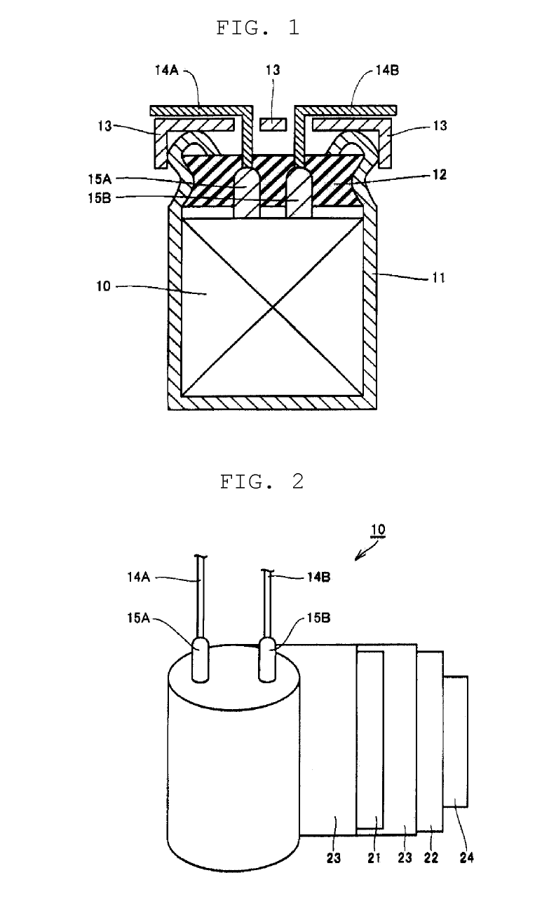

FIG. 1 is a schematic sectional view illustrating the electrolytic capacitor according to the present exemplary embodiment, and FIG. 2 is a schematic view obtained by developing a part of a capacitor element of the electrolytic capacitor.

The electrolytic capacitor includes, for example, capacitor element 10, bottomed case 11 that houses capacitor element 10, sealing member 12 that seals an opening of bottomed case 11, base plate 13 that covers sealing member 12, lead wires 14A, 14B that are lead out from sealing member 12 and penetrate base plate 13, lead tabs 15A, 15B that connect the lead wires 14A, 14B to electrodes of capacitor element 10, respectively, and an electrolyte solution (not shown). Bottomed case 11 is, at a part near an opening end, processed inward by drawing, and is, at the opening end, curled for swaging to sealing member 12.

Capacitor element 10 is formed of a wound body as illustrated in FIG. 2. The wound body is a semi-manufactured product of capacitor element 10 and refers to a capacitor element in which the solid electrolyte layer including the conductive polymer has not yet been formed between anode body 21 on a surface of which the dielectric layer is provided and cathode body 22. The wound body includes anode body 21 connected to lead tab 15A, cathode body 22 connected to lead tab 15B, and separator 23. Anode body 21 and cathode body 22 are wound with separator 23 interposed between the anode body and the cathode body. An outermost periphery of the wound body is fixed with fastening tape 24. FIG. 2 shows partially developed wound body before the outermost periphery of the wound body is fixed.

Anode body 21 includes a metal foil whose surface is roughened so as to have projections and recesses, and the dielectric layer is formed on the metal foil having the projections and recesses. The conductive polymer is attached to at least a part of a surface of the dielectric layer to form the solid electrolyte layer. The solid electrolyte layer may cover at least a part of a surface of cathode body 22 and/or at least a part of a surface of separator 23. Capacitor element 10 in which the solid electrolyte layer has been formed may be housed in an outer case together with the electrolyte solution.

### Method for Producing Electrolytic Capacitor

Hereinafter, described are steps of one exemplary method for producing the electrolytic capacitor according to the present exemplary embodiment.

### (i) Step of Preparing Anode Body 21 Including Dielectric Layer

First, a raw material for anode body 21, i.e. a metal foil is prepared. A type of the metal is not particularly limited, but it is preferable to use a valve metal such as aluminum, tantalum, or niobium, or an alloy including a valve metal, from the viewpoint of facilitating formation of the dielectric layer.

Next, a surface of the metal foil is roughened. By the roughening, a plurality of projections and recesses are formed on the surface of the metal foil. The roughening is preferably performed by etching the metal foil. The etching may be performed by, for example, a DC electrolytic method or an AC electrolytic method.

Next, a dielectric layer is formed on the roughened surface of the metal foil. A method for forming the dielectric layer is not particularly limited, and the dielectric layer can be formed by subjecting the metal foil to an anodizing treatment. The anodizing treatment is performed by, for example, immersing the metal foil in an anodizing solution such as an ammonium adipate solution followed by a heat treatment. The anodizing treatment may also be performed by applying a voltage to the metal foil that has been immersed in the anodizing solution.

Normally, a large foil of, for example, a valve metal (metal foil) is subjected to the roughening treatment and the anodizing treatment from the viewpoint of mass productivity. In this case, the treated foil is cut into a desired size to prepare anode body 21.

### (ii) Step of Preparing Cathode Body 22

A metal foil can also be used for cathode body 22 as with the anode body. A type of the metal is not particularly limited, but it is preferable to use a valve metal such as aluminum, tantalum, or niobium, or an alloy including a valve metal. A surface of cathode body 22 may also be roughened as necessary.

### (iii) Manufacturing of Wound Body

Next, anode body 21 and cathode body 22 are used to manufacture a wound body.

First, anode body 21 and cathode body 22 are wound with separator 23 interposed between the anode body and the cathode body. At this time, the winding can be conducted while lead tabs 15A, 15B are rolled in the anode body, the cathode body, and the separator, to cause lead tabs 15A, 15B to stand up from the wound body as illustrated in FIG. 2.

As a material for separator 23, a nonwoven fabric can be used that includes, as a main component, for example, synthetic cellulose, polyethylene terephthalate, a vinylon, or an aramid fiber.

A material for lead tabs 15A, 15B is not also particularly limited as long as the material is a conductive material. A material for lead wires 14A, 14B connected to lead tabs 15A, 15B, respectively, is not also particularly limited as long as the material is a conductive material.

Next, fastening tape 24 is disposed on an outer surface of cathode body 22 positioned at an outermost layer of wound anode body 21, cathode body 22, and separator 23, to fix an end of cathode body 22 with fastening tape 24.

When anode body 21 is prepared by cutting a large metal foil, the wound body may further be subjected to an anodizing treatment in order to provide a dielectric layer on a cutting surface of anode body 21.

### (iv) Step of Forming Capacitor Element 10

Next, a conductive polymer solution obtained by dissolving a conductive polymer in a third solvent or a conductive polymer dispersion liquid containing the third solvent and particles of the conductive polymer (hereinafter, sometimes collectively referred to as a liquid composition) is applied to a surface of the dielectric layer and then dried to form a solid electrolyte layer, so that capacitor element 10 is formed.

The conductive polymer contained in the conductive polymer solution is dissolved in the third solvent and uniformly distributed in the solution. Therefore, the conductive polymer solution is preferable in terms of easy formation of a more uniform solid electrolyte layer. The conductive polymer contained in the conductive polymer dispersion liquid is dispersed in the third solvent in a state of particles or a powder. The conductive polymer dispersion liquid can be obtained by, for example, a method for dispersing the conductive polymer in the third solvent or a method for polymerizing a precursor monomer of the conductive polymer in the third solvent and generating particles of the conductive polymer in the third solvent.

A concentration of the conductive polymer in the conductive polymer solution preferably ranges from 0.5% by mass to 10% by mass, inclusive, and a concentration of particles or a powder of the conductive polymer in the conductive polymer dispersion liquid also preferably ranges from 0.5% by mass to 10% by mass, inclusive. The liquid composition having such a concentration is suitable for forming a solid electrolyte layer that has an appropriate thickness and is easily impregnated into the wound body.

The solid electrolyte layer may be formed by a method for applying a solution containing, for example, a monomer, a dopant, and an oxidant to the dielectric layer to cause chemical polymerization on the dielectric layer. Especially, the solid electrolyte layer is preferably formed by a method for applying the conductive polymer to the dielectric layer in terms of the fact that excellent withstand voltage characteristics can be expected.

The conductive polymer may include a dopant. As the dopant, there can be exemplified an anion of, for example, polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, and polyacrylic acid. These dopants may be used alone or in combination of two or more dopants. These dopants may be a homopolymer or a copolymer of two or more monomers. Especially, a polyanion derived from polystyrenesulfonic acid is preferable.

A weight average molecular weight of the conductive polymer is not particularly limited and ranges, for example, from 1000 to 100000, inclusive. A weight average molecular weight of the polyanion is not particularly limited and ranges, for example, from 1000 to 100000, inclusive. The conductive polymer and the polyanion that have such a weight average molecular weight are likely to form a uniform solid electrolyte layer. When the conductive polymer is dispersed in a dispersion medium in a state of particles or a powder, the particles or the powder preferably has an average particle diameter D50 ranging, for example, from 0.01 μm to 0.5 μm, inclusive. Here, the average particle diameter D50 is a median diameter in a volume particle size distribution obtained by a particle size distribution measuring apparatus according to dynamic light scattering.

A concentration of the conductive polymer (including the dopant) in the liquid composition preferably ranges from 0.5% by mass to 10% by mass, inclusive. The liquid composition having such a concentration is suitable for forming a solid electrolyte layer having an appropriate thickness and is easily impregnated into the wound body to advantageously improve productivity.

The third solvent may be water, a mixture of water and a nonaqueous solvent, or a nonaqueous solvent. The nonaqueous solvent is a collective term for liquids except water and includes an organic solvent and an ionic liquid. The nonaqueous solvent is not particularly limited, and a protic solvent and an aprotic solvent can be used, for example. Examples of the protic solvent include alcohols such as methanol, ethanol, propanol, butanol, ethylene glycol, and propylene glycol, formaldehyde, and ethers such as 1,4-dioxane.

Examples of the aprotic solvent include amides such as N-methylacetamide, N,N-dimethylformamide, and N-methyl-2-pyrrolidone, esters such as methyl acetate, and ketones such as methyl ethyl ketone.

A method for applying the liquid composition to a surface of the dielectric layer is not particularly limited. However, for example, a method for immersing the wound body in the liquid composition housed in a container is preferably simple. An immersion period depends on a size of the wound body, and ranges, for example, from 1 second to 5 hours, preferably from 1 minute to 30 minutes. In addition, impregnation is preferably performed under a reduced pressure in an atmosphere ranging, for example, from 10 kPa to 100 kPa, inclusive, preferably from 40 kPa to 100 kPa, inclusive. Further, ultrasonic vibration may be applied to the wound body or the liquid composition while the wound body is immersed in the liquid composition.

After the wound body is picked up from the liquid composition, the wound body may be heated to accelerate evaporation of water and/or the nonaqueous solvent contained in the liquid composition. A heating temperature ranges preferably from 50° C. to 300° C., inclusive, particularly preferably from 100° C. to 200° C., inclusive, for example.

The step of applying the liquid composition to a surface of the dielectric layer and the step of drying the wound body may be repeated two or more times. These steps can be performed a plurality of times to increase coverage of the solid electrolyte layer on the dielectric layer. The solid electrolyte layer is formed so as to cover at least a part of the surface of the dielectric layer. In the formation, the solid electrolyte layer may be formed on not only a surface of the dielectric layer but also surfaces of cathode body 22 and separator 23.

As described above, the solid electrolyte layer is formed between anode body 21 and cathode body 22 to manufacture capacitor element 10. The solid electrolyte layer formed on a surface of the dielectric layer actually functions as a cathode material.

### (v) Step of Impregnating Capacitor Element 10 With Nonaqueous Solvent or Electrolyte Solution

Next, capacitor element 10 is impregnated with a nonaqueous solvent containing the first solvent and the second solvent. The first solvent and the second solvent may be mixed in advance. The nonaqueous solvent infiltrates into a gap that capacitor element 10 has. The nonaqueous solvent can also infiltrate into a gap of the dielectric layer which is not covered with the solid electrolyte layer. Therefore, a restoration function of the dielectric layer is improved.

As the nonaqueous solvent, an electrolyte solution that is obtained by dissolving an organic salt as an ionic substance (solute) may be used. The organic salt is a salt in which at least one of an anion and a cation includes an organic substance. As the organic salt, an organic amine salt is preferable, and a salt of an organic amine and an organic carboxylic acid is particularly preferable. Specifically, there can be used trimethylamine maleate, triethylamine borodisalicylate, ethyldimethylamine phthalate, mono(1,2,3,4-tetramethylimidazolinium) phthalate, and mono(1,3-dimethyl-2-ethylimidazolinium) phthalate.

A method for impregnating capacitor element 10 with a nonaqueous solvent or an electrolyte solution is not particularly limited. Especially, a method for immersing capacitor element 10 in the nonaqueous solvent or the electrolyte solution housed in a container is preferable in terms of simpleness of the method. An immersion period depends on a size of capacitor element 10, and ranges, for example, from 1 second to 5 minutes. In addition, impregnation is preferably performed under a reduced pressure in an atmosphere ranging, for example, from 10 kPa to 100 kPa, inclusive, preferably from 40 kPa to 100 kPa, inclusive.

### (iv) Step of Encapsulating Capacitor Element

Next, capacitor element 10 is encapsulated. Specifically, first, capacitor element 10 is housed in bottomed case 11 so that lead wires 14A, 14B are positioned on an open upper surface of bottomed case 11. As a material for bottomed case 11, there can be used metals such as aluminum, stainless steel, copper, iron and brass, or alloys of these metals.

Next, sealing member 12 formed so as to allow lead wires 14A, 14B to penetrate the sealing member is disposed above capacitor element 10 to encapsulate capacitor element 10 in bottomed case 11. Sealing member 12 is sufficient as long as the sealing member is an insulating substance. As the insulating substance, an elastic body is preferable, and, for example, high heat resistance silicone rubber, fluororubber, ethylene propylene rubber, Hypalon (trademark) rubber, butyl rubber or isoprene rubber is especially preferable.

Next, bottomed case 11 is, at a part near an opening end, processed by transverse drawing, and is, at the opening end, curled for swaging to sealing member 12. Then, base plate 13 is disposed on a curled part of the bottomed case to complete the electrolytic capacitor as illustrated in FIG. 1. Subsequently, an aging treatment may be performed while a rated voltage is applied.

In the exemplary embodiment described above, a wound electrolytic capacitor has been described. The application range of the present disclosure, however, is not limited to the wound electrolytic capacitor and can also be applied to other electrolytic capacitors such as a chip electrolytic capacitor including a metal sintered body as an anode body, and a laminated electrolytic capacitor including a metal plate as an anode body.

### EXAMPLES

Hereinafter, the present disclosure is described in more detail with reference to examples. The present disclosure, however, is not limited to the examples.

### Example 1

In the present example, a wound electrolytic capacitor (Φ (diameter): 8.0 mm×L (length): 12.0 mm) having a rated voltage of 100 V and a rated electrostatic capacity of 15 μF was produced. Hereinafter, a specific method for producing the electrolytic capacitor is described.

### Preparation of Anode Body

A 100-μm-thick aluminum foil was subjected to etching to roughen a surface of the aluminum foil. Then, a dielectric layer was formed on the surface of the aluminum foil by an anodizing treatment. The anodizing treatment was performed by immersing the aluminum foil in an ammonium adipate solution and applying a voltage of 60 V to the aluminum foil. Then, the aluminum foil was cut into a size of 6 mm (length)×120 mm (width) to prepare an anode body.

### Preparation of Cathode Body

A 50-μm-thick aluminum foil was subjected to etching to roughen a surface of the aluminum foil. Then, the aluminum foil was cut into a size of 6 mm (length)×120 mm (width) to prepare a cathode body.

### Manufacturing of Wound Body

An anode lead tab and a cathode lead tab were connected to the anode body and the cathode body, respectively, and the anode body and the cathode body were wound with a separator interposed between the anode body and the cathode body while the lead tabs were rolled in the anode body, the cathode body, and the separator. Ends of the lead tabs protruding from the wound body were connected to an anode lead wire and a cathode lead wire, respectively. Then, the manufactured wound body was subjected to an anodizing treatment again to form a dielectric layer at a cutting end of the anode body. Next, an end of an outer surface of the wound body was fixed with a fastening tape to manufacture the wound body.

### Preparation of Conductive Polymer Dispersion Liquid

A mixed solution was prepared by dissolving 3,4-ethylenedioxythiophene and a dopant, or polystyrenesulfonic acid in ion-exchanged water (third solvent). While the resultant mixed solution was stirred, iron (III) sulfate (oxidant) that had been dissolved in ion-exchanged water was added to the mixed solution to cause a polymerization reaction. After the reaction, a resultant reaction solution was dialyzed to remove unreacted monomers and an excessive oxidant, so that a conductive polymer dispersion liquid was obtained that included about 5 mass % of polyethylene dioxythiophene doped with polystyrenesulfonic acid.

### Formation of Solid Electrolyte Layer

The wound body was immersed in the conductive polymer dispersion liquid housed in a predetermined container in a reduced atmosphere (40 kPa) for 5 minutes, and then the wound body was picked up from the conductive polymer dispersion liquid. Next, the wound body that had been impregnated with the conductive polymer dispersion liquid was dried in a drying furnace at 150° C. for 20 minutes to form a solid electrolyte layer including the conductive polymer between the anode member and the cathode member, thus forming a capacitor element.

### Impregnation with Nonaqueous Solvent or Electrolyte Solution

The capacitor element including the solid electrolyte layer was immersed in a mixed solvent of PC and GBL (mass ratio, PC:GBL=4:6) in a reduced atmosphere (40 kPa) for 5 minutes.

### Encapsulation of Capacitor Element

The capacitor element that had been impregnated with the nonaqueous solvent was encapsulated to complete an electrolytic capacitor. Specifically, first, the capacitor element was housed in a bottomed case so that lead wires are positioned at an opening side of the bottomed case, and rubber packing, as a sealing member, which was formed so as to allow the lead wires to penetrate the rubber packing was disposed above the capacitor element. According to this, the capacitor element was encapsulated in the bottomed case. The bottomed case was, at a part near an opening end, processed by drawing and was further curled at the opening end, and a base plate was disposed on a curled part to complete the electrolytic capacitor as illustrated in FIG. 1. Then, an aging treatment was performed at 130° C. for 2 hours while a rated voltage was applied.

Electrostatic capacity, ESR, and a breakdown voltage (BDV) were measured for the resultant electrolytic capacitor. The breakdown voltage (BDV) was defined as a voltage measured when an excess current of 0.5 A flows by applying the voltage at an increasing rate of 1.0 V/s.

Further, in order to evaluate long term reliability, the electrolytic capacitor was retained at 125° C. for 5000 hours while a rated voltage was applied, and a change rate in electrostatic capacity (ΔCap₁₂₅) and an increase rate in ESR (ΔESR₁₂₅) were evaluated. The change rate ΔCap₁₂₅ was calculated by the formula [(X·X₀)/X₀]×100, with initial electrostatic capacity defined as Xo and electrostatic capacity after retention for 5000 hours defined as X. The increase rate ΔESR₁₂₅ was represented by the ratio (Y/Y₀) of a value of ESR (Y) after retention for 5000 hours to an initial value of ESR (Y₀).

Further, in order to evaluate temperature characteristics, a change rate in electrostatic capacity at −60° C. to 105° C. (ΔCapₜₑₘ) was evaluated. The change rate ΔCapₜₑₘ was calculated as a change rate in electrostatic capacity Zₜₑₘ at each temperature with electrostatic capacity Z₀ at 25° C. as a standard, the change rate ΔCapₜₑₘ being denoted by ([(Zₜₑₘ·Z₀)/Z₀]×100). The characteristics were obtained from an average value of 30 samples. Table 1 shows results of the evaluation.

### Examples 2 to 3 and Comparative Examples 1 to 4

Electrolytic capacitors of Examples 2 to 3 and Comparative Examples 1 to 4 were produced in the same manner as in Example 1 except that the first solvent and the second solvent as shown in Table 1 were used, or were produced in the same manner as in Example 1 except that either one of the first solvent and the second solvent was not used as shown in Table 1. And the evaluation was performed in the same manner as above. Table 1 shows results of the evaluation.

TABLE 1

| | First | | | | | |
|---|---|---|---|---|---|---|
| | solvent:Second | X₀/Y₀ | BDV | | | ΔESR₁₂₅ |
| | solvent | [uF/mΩ] | [V] | ΔCapₜₑₘ | ΔCap₁₂₅ | [Ratio] |
| Example 1 | PC:GBL | 15.2/18.8 | 210.4 | −8% to 8% | −6.2% | 1.8 |
| | 4:6 | | | | | |
| Example 2 | PC:Sulfolane | 15.1/19.0 | 213.2 | −9% to 9% | −2.6% | 1.6 |
| | 4:6 | | | | | |
| Example 3 | PC:EG | 15.0/18.8 | 197.6 | −9% to 8% | −6.8% | 1.9 |
| | 4:6 | | | | | |
| Comparative Example 1 | PC:— | 15.1/19.3 | 212 | −12% to 8% | −25.8% | 4.2 |
| | 10:0 | | | | | |
| Comparative Example 2 | —:GBL | 14.9/18.4 | 211.3 | −9% to 7% | −10.5% | 2.4 |
| | 0:10 | | | | | |
| Comparative Example 3 | —:Sulfolane | 14.7/18.8 | 213.4 | −18% to 9% | −1.2% | 1.4 |
| | 0:10 | | | | | |
| Comparative Example 4 | —:EG | 15.0/18.2 | 174.1 | −9% to 8% | −3.5% | 8.4 |
| | 0:10 | | | | | |

In Examples 1 to 3, particularly, the change rate in capacity (ΔCap₁₂₅) at the high temperature is small and an increase in ESR is suppressed in comparison with cases of Comparative Example 1 where only PC was used as the solvent and Comparative Example 2 where only GBL was used as the solvent. In addition, in Comparative Example 3 where only sulfolane was used, it is understood that the electrolytic capacitor is inferior in low temperature characteristics from the fact that the range of the ΔCapₜₑₘ becomes wide in comparison with the range of the ΔCap₁₂₅. In Comparative Example 4 where only EG was used, the withstand voltage characteristics is very low and the ESR is increased.

### Examples 4 to 6

Electrolytic capacitors of Examples 4 to 6 were produced in the same manner as in Example 1 except that the ratios between the first solvent and the second solvent were changed as shown in Table 2. And the evaluation was performed in the same manner as above. Table 2 shows results of the evaluation.

TABLE 2

| | First | | | | | |
|---|---|---|---|---|---|---|
| | solvent:Second | X₀/Y₀ | BDV | | | ΔESR₁₂₅ |
| | solvent | [uF/mΩ] | [V] | ΔCapₜₑₘ | ΔCap₁₂₅ | [Ratio] |
| Comparative Example 1 | PC:− | 15.1/19.3 | 212 | −12% to 8% | −25.8% | 4.2 |
| | 10:0 | | | | | |
| Example 4 | PC:Sulfolane | 14.9/18.9 | 213.4 | −8% to 9% | −2.6% | 1.6 |
| | 5:5 | | | | | |
| Example 2 | PC:Sulfolane | 15.1/19.0 | 213.2 | −9% to 9% | −2.6% | 1.6 |
| | 4:6 | | | | | |
| Example 5 | PC:Sulfolane | 15.0/18.9 | 214.1 | −7% to 8% | −2.4% | 1.5 |
| | 3:7 | | | | | |
| Example 6 | PC:Sulfolane | 14.9/18.9 | 213.7 | −11% to 9% | −1.8% | 1.5 |
| | 2:8 | | | | | |
| Comparative Example 3 | −:Sulfolane | 14.7/18.8 | 213.4 | −18% to 9% | −1.2% | 1.4 |
| | 0:10 | | | | | |

In Examples 2 and 4 to 6 where the first solvent and the second solvent were contained in a ratio ranging from 2:8 to 5:5 (first solvent:second solvent), the change rate in capacity caused by a change in temperature (ΔCapₜₑₘ) is small and further, the withstand voltage characteristics are excellent. Especially, in Examples 2, 4, and 5 where the first solvent and the second solvent were contained in a ratio ranging from 3:7 to 5:5 (first solvent:second solvent), the change in capacity caused by a change in temperature is particularly small.

The present disclosure can be utilized for an electrolytic capacitor including a solid electrolyte layer as a cathode material.

What is claimed is:

1. An electrolytic capacitor comprising:
an anode member including a dielectric layer;
a solid electrolyte layer that is formed on a surface of the dielectric layer and includes a conductive polymer; and
a nonaqueous solvent or an electrolyte solution,
wherein the nonaqueous solvent or the electrolyte solution includes:
a first solvent that contains at least one selected from the group consisting of a carbonate ester and a derivative of the carbonate ester; and
a second solvent different from the first solvent.

2. The electrolytic capacitor according to claim 1, wherein the carbonate ester is at least one selected from the group consisting of dimethyl carbonate, diethyl carbonate, ethylene carbonate, and propylene carbonate.

3. The electrolytic capacitor according to claim 1, wherein the second solvent contains at least one selected from the group consisting of ethylene glycol, γ-butyrolactone, and sulfolane.

4. The electrolytic capacitor according to claim 1, wherein a mass ratio between the first solvent and the second solvent, which is first solvent:second solvent, ranges from 3:7 to 5:5.

5. The electrolytic capacitor according to claim 1, wherein the conductive polymer includes at least one selected from the group consisting of polypyrrole, polythiophene, polyaniline, and derivatives thereof.

6. The electrolytic capacitor according to claim 1, wherein the solid electrolyte layer is formed by applying a conductive polymer solution or a conductive polymer dispersion liquid to a surface of the dielectric layer and then drying the conductive polymer solution or the conductive polymer dispersion liquid, the conductive polymer solution being obtained by dissolving the conductive polymer in a third solvent and the conductive polymer dispersion liquid containing the third solvent and particles of the conductive polymer.

7. A method for manufacturing the electrolytic capacitor according to claim 1, the method comprising forming the solid electrolyte layer by applying a conductive polymer solution or a conductive polymer dispersion liquid to a surface of the dielectric layer and then drying the conductive polymer solution or the conductive polymer dispersion liquid, the conductive polymer solution being obtained by dissolving the conductive polymer in a third solvent and the conductive polymer dispersion liquid containing the third solvent and particles of the conductive polymer.
